(19) United States
(12) Patent Application Publication
(10) Pub. No.: US 2026/0065012 A1
(43) Pub. Date: Mar. 5, 2026

(54) CHATBOT EVENT GENERATION SYSTEM LEVERAGING LLM CAPABILITIES

(71) Applicant: SAP SE, Walldorf (DE)

(72) Inventors: Yongxing PAN, Shanghai (CN); Jun HUANG, Shanghai (CN); Huan YANG, Shanghai (CN); Qi CHEN, Shanghai (CN)

(21) Appl. No.: 18/820,407

(22) Filed: Aug. 30, 2024

(51) Int. Cl. G06N 3/006; G06N 3/0475

(52) U.S. Cl. CPC G06N 3/006; G06N 3/0475

(57) ABSTRACT

System, method, and various embodiments for a chatbot event generation system are described herein. An embodiment operates by receiving a request to create an event, and identifying a set of parameters associated with generating the event. A first subset of parameters as provided with the request are identified. A prompt for a large language model (LLM) is generated, and a second subset of parameters is received from the LLM. The event is generated based on the first subset of parameters provided with the request and the second subset of parameters provided by the LLM. The event is detected and an additional action is performed responsive to the detecting the event.

### BACKGROUND

The detection of an event can be an important functionality of a computing system, because different events can have various real-world implications. Oftentimes a user will want a computing system to detect when a specific user-defined event occurs within the computing system. However, generating such a user-defined event is a highly technical task that is often unavailable to run-time users. As such, would-be computing events occurring in a computing system may go undetected which could adversely impact the throughput and accuracy of results generated by a computing system, or a decision-making process by the user.

### BRIEF DESCRIPTION OF THE DRAWINGS

The accompanying drawings are incorporated herein and form a part of the specification.

FIG. 1 is a block diagram 100 illustrating example functionality for a chatbot event generation system (EGS), according to some embodiments.

FIG. 2 is a chart illustrating example operations for providing an event generation system (EGS), according to some embodiments.

FIG. 3 is a flowchart illustrating example operations for providing an event generation system (EGS), according to some embodiments

FIG. 4 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a chatbot event generation system leveraging LLM capabilities.

The detection of an event can be an important functionality of a computing system, because different events can have various real-world implications. Oftentimes a user will want a computing system to detect when a specific user-defined event occurs within the computing system. However, generating such a user-defined event is a highly technical task that is often unavailable to run-time users. As such, would-be computing events occurring in a computing system may go undetected which could adversely impact the throughput and accuracy of results generated by a computing system, or a decision-making process by the user.

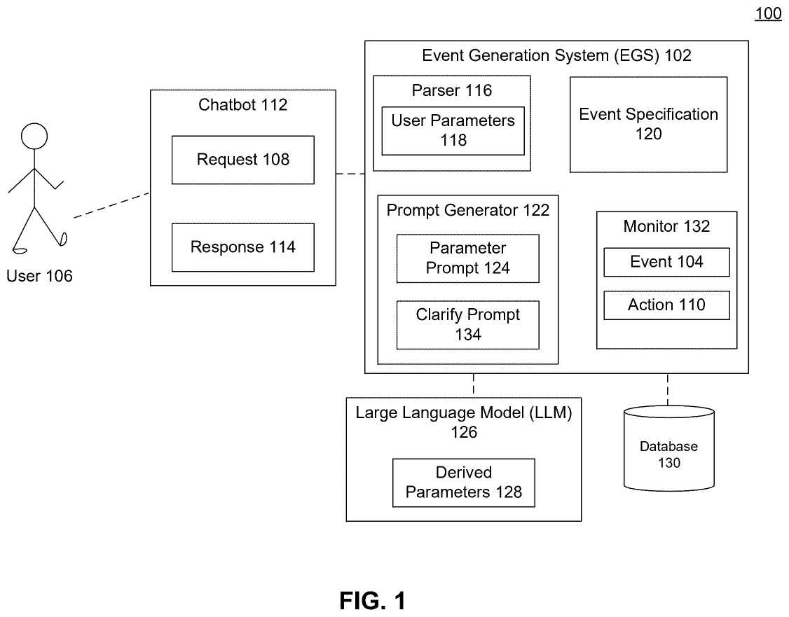

FIG. 1 is a block diagram 100 illustrating example functionality for a chatbot event generation system (EGS) 102, according to some embodiments. EGS 102 may allow a user 106 to generate an event 104 on a database 130 during runtime processes of the database 130 and/or another computing program or system that is accessing and updating data in the database 130. EGS 102 makes runtime event-generation by a user 106 possible. Additionally, EGS 102 simplifies the highly technical event-generation process for a runtime user 106.

For example, generating an event 104 may generally be a highly technical process requiring a number of technical parameters inaccessible to most runtime users 106, and prone to human errors. Rather than requiring the user 106 to access or provide parameters which may be difficult or impossible for the user 106 to determine, EGS 102 allows the user 106 to provide any user parameters 118 to which the user 106 has access through a chatbot interface 112. EGS 102 may then leverage a large language model (LLM) 126 to generate the remaining derived parameters 128, which may be necessary to generate the event 104 intended or requested by the user 106.

This derivation of parameters makes generating an event 104 accessible to a user 106 and minimizes the back-and-forth processing that would otherwise be required if the user 106 was to provide incorrect or incomplete input, thus improving overall computing and system throughput. Further the creation and subsequent detection of event 104 may cause EGS 102 to perform an action 110 based on the detection, which may improve computing functionality and/or output.

In some embodiments, user 106 may submit a request 108 to a chatbot 112. Chatbot 112 may include a computer program that is designed to simulate a conversation with a human user. Chatbot 112 may include any interface that enables a user to access chatbot functionality or interact with a chatbot. In some embodiments, chatbot 112 may be accessible via the internet (e.g., through a website), a messaging application (including textual and/or audio communications), or any add on messaging service that enables two-way communications. Chatbot 112 may allow a user to speak and/or type input, such as request 108. Chatbot 112 may provide a response 114 in audio, text, or multimedia format, including hyperlinks.

In some embodiments, chatbot 112 may be trained to respond to particular user inputs, based on identifying particular keywords. In some embodiments, chatbot 112 may perform initial NLP (natural language processing) on the request 108 (or other user input). For example, request 108 may include a natural-language input from user 106 such as “Please create an event for when the ship-date of the data record for purchase order 1234 is updated”.

In some embodiments, a parser 116 may parse the submitted request 108 for a set of user parameters 118. The user parameters 118 may include any information provided in request 108 that may be used to generate a corresponding event 104. In continuing the example above, the user parameters 118 may include “ship-date” and “purchase order 1234”. However, generating the event 104 may require additional parameters beyond the user parameters 118 identified in the request 108.

In some embodiments, an event specification 120 may detail the complete set of parameters that may be needed to generate an event 104. Example parameters may include (but are not limited to): id (unique identifier of the event, which may be assigned by the system), source (application associated with the event), source-region (portion of application event is associated with), type (type of event), data object (name of any data object associated with the event), schema (schema associated with the event), expiration (expiration date of the event), action (what action is to be performed upon detection of the event), time (timestamp of when the event was created), etc. In some embodiments, event specification 120 may indicate which parameters are required from the user 106, and which parameters may be derived from the user parameters 118.

In some embodiments, parser 116 may compare the request 108 to the event specification 120 to identify which user parameters 118 were provided with request 108, and which parameters are missing, were not provided by the user 106, or are still required to generate event 104.

In some embodiments, identifying user parameters 118 with parser 116 may improve speed of processing, relative to relying on LLM 126 to identify both user parameters 118 and derived parameters 128 in accordance with event specification 120, as may be done in other embodiments. In some embodiments, user parameters 118 may include all the necessary parameters to create a new event 104 (in accordance with event specification 120), or all the necessary parameters to perform another function (e.g., such as search, remove, activate/deactivate), and as such, both prompt generation and usage of LLM 126 may be bypassed for faster processing.

In some embodiments, a prompt generator 122 may generate a parameter prompt 124. A prompt, such as parameter prompt 124, may include one or more lines of text organized across one or more documents that is particularly formatted to by understandable by an LLM 126. LLM 126 may include an artificial intelligence, machine learning, or deep learning model that is configured to execute data processing commands from plain-text (e.g., not requiring computer language or coded input). LLM 126 may include any computing system that is configured to perform processing tasks based on text-based or plain language inputs. LLM 126 may be configured to create original content from one or more documents or input in accordance with a prompt. In some embodiments, LLM 126 may include a generative pre-training transformer (GPT).

Parameter prompt 124 may be a prompt generated to request a set of derived parameters 128 from LLM 126. In some embodiments, prompt generator 122 may provide request 108 and/or user parameters 118 as input for the parameter prompt 124, and request a set of derived parameters 128 as output from the LLM 126. Derived parameters 128 may include any parameters of event specification 120 which are not directly included in request 108 or otherwise provided by user 106. In some embodiments, the complete set of parameters from event specification 120 may include the user parameters 118 and the derived parameters 128.

In some embodiments, chatbot 112 may receive request 108, and parser 116 may determine that the request 108 is a command to generate an event 104. Then, for example, prompt generator 122 may provide the request 108 as input as parameter prompt 124, and request both user parameters 118 and derived parameters 128 (e.g., the required parameters as indicated by event specification 120) as output from the LLM 126.

Upon receiving the derived parameters 128, EGS 102 may combine the user parameters 118 and derived parameters 128 to generate the corresponding event 104. In some embodiments, if the event 104 was successfully generated, chatbot 112 may issue a response 114 indicating a successful creation of the event 104. Similarly, if the event creation fails, then chatbot 112 may provide an indication of the failure via response 114.

In some embodiments, the user 106 may not provide enough information to generate an event 104. For example, the request 108 may be a request to “create event” without any additional information. In some embodiments, if parser 116 is unable to detect any user parameters 118 in request 108, then chatbot 112 may generate a response 114 requesting the user 106 for the missing user parameter(s) 118 (e.g., as determined from event specification 120). This may be more computationally efficient than generating the parameter prompt 124 and invoking the processing of LLM 126 to determine that the request 108 is lacking the necessary user parameters 118 to generate event 104. Once parser 116 determines that the request 108 (e.g., or subsequent request 108 with any missing parameters) includes the requisite user parameters 118, then prompt generator 122 may generate a parameter prompt 124 as described herein.

In some embodiments, the request 108 may include text that the chatbot 112 cannot understand (e.g., because of misspellings, missing letters or words, etc.). Then, for example, prompt generator 122 may generate a clarify prompt 134 with the request 108 as input, requesting LLM 126 to confirm whether the request 108 is to generate an event and/or request user parameters 118 from request 108. If the LLM 126 is able to detect the necessary user parameters 118, then prompt generator 122 may then generate the parameter prompt 124 as described above. If the response from LLM 126 does not correspond to the user parameters 118, then response 114 may be a request for user 106 to submit a new request 108 or an indication that the creation of a new event 104 failed.

In some embodiments, the event 104 may be an event to be detected on a database 130. For example, the event 104 may identify a particular data record, column, or table of data from database 130 that when updated, triggers the event 104. A data update may include adding new data, deleting existing data, or updating existing data.

In some embodiments, a monitor 132 may monitor the operations of database 130 to determine if and when any registered event 104 is detected. In some embodiments, monitor 132 may include an event manager that has access to the status of which event(s) 104 are active or inactive.

Upon the detection of event 104, EGS 102 may perform an action 110. Action 110 may include any computing action that may be performed upon detection of event 104. For example, action 110 may include stopping one or more operations from being performed on database 130, until a user 106 gives approval to continue with data processing. Or, for example, action 110 may include notifying the user 106 (e.g., via a response 114 through chatbot 112, or another electronic communication such as email, text, or phone call) that the event 104 has been detected. In some embodiments, the notification may include additional information such as a timestamp of the event 104, and indication of what data was added, updated, or deleted.

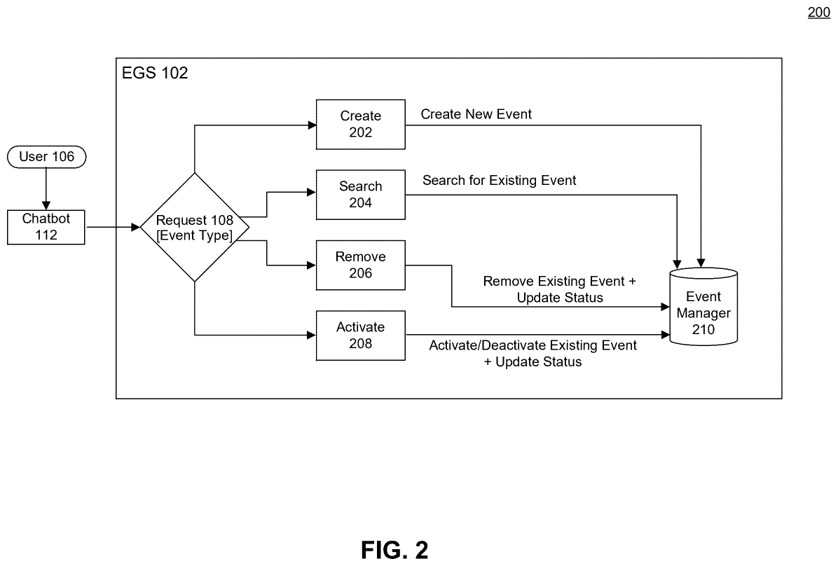

FIG. 2 is a chart 200 illustrating example operations for providing an event generation system (EGS) 102, according to some embodiments. User 106 may interact with a chatbot 112 providing various comments and receiving various responses. User 106 may submit a request to create or update an event 104 and may provide information regarding the event 104.

In some embodiments, parser 116 (of EGS 102) may determine an event type associated with the request 108. The event type may indicate what type of operation is to be performed, such as a create, search, remove, or activate/deactivate request. In some embodiments, parser 116 may identify the event type based on identifying various keywords which may have been included in or with request 108. In some embodiments, prompt generator 122 may generate a prompt, such as clarify prompt 134, to request LLM 126 to identify the event type from request 108.

If the event type is a create command, then at create 202, EGS 102 may create a new event. For example, as described above, prompt generator 122 may create a parameter prompt 124, receive derived parameters 128 from LLM 126, and generate a new event 104.

In some embodiments, an event manager 210 may manage the events 104 which are created. The event manager 210 may include a data storage system or processor that tracks the status of various events (e.g., active, inactive, deleted, etc.). As referenced above, event manager 210 may be communicatively coupled with monitor 132.

If the event type is a search command, then at search 204, EGS 102 may perform a search or generate a query for an existing event 104 (or set of events) as indicated by request 108. The query may be submitted to event manager 210, which may return any resulting events 104 that match the query. User 106 may receive the event(s) 104 and submit a subsequent request 108 (e.g., remove, activate/deactivate) regarding one of the identified events or create a new event.

If the event type is a remove command, then at remove 206, EGS 102 may delete an existing event 104 from event manager 210. In some embodiments, rather than deleting the event 104 entirely, the status of the event may be marked as “deleted” and removed or garbage collected after the expiration of some threshold period of time (e.g., 90 days), thus giving the user 106 the option of rolling back the delete operation at a later time. In some embodiments, the status of an existing event may be marked as deleted and provided with a delete timestamp, indicating the date of deletion and/or user identifier corresponding to the user 106 who deleted the event 104.

If the event type is an activate/deactivate command, then at activate 208, the status of the event 104 in event manager 210 may be changed to active or inactive. In some embodiments, the activate command may be provided with a time period of expiration, such that after the expiration, the event is automatically deactivated. Similarly, the deactivate command may be provided with a time period of expiration, such that after the expiration, the event is automatically activated again.

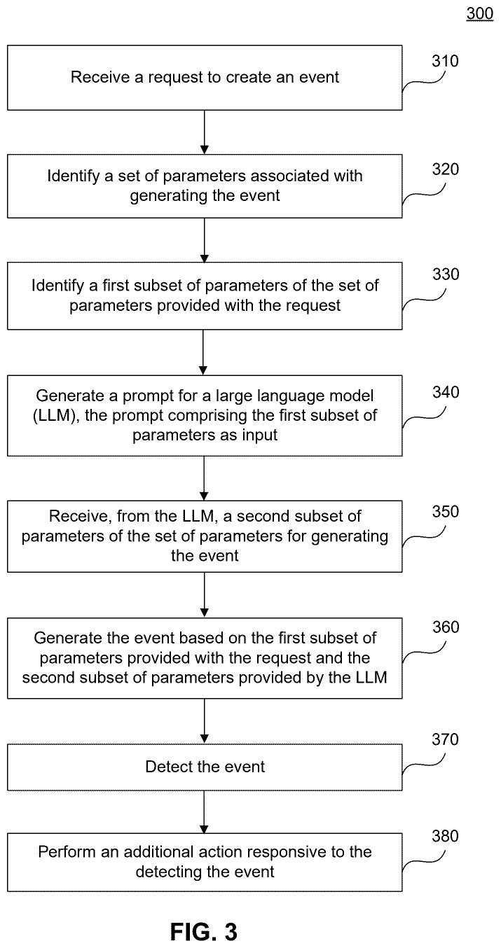

FIG. 3 is a flowchart 300 illustrating example operations for providing an event generation system (EGS) 102, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1.

In 310, a request to generate an event is received. For example, chatbot 112 may receive a request 108 from a user 106. The request 108 may include a plain-language request by user 106 to create or generate an event 104, and may include some specifics about the event 104 to be created.

In 320, a set of parameters associated with generating the event is identified. For example, EGS 102 may identify a full set of necessary and optional parameters for creating or generating a new event 104, from event specification 120. Event specification 120 may include a document, library, database, or other information that indicates what parameters may be necessary to create a new event 104. Example parameters include requester, program, expiration, action (e.g., indicating what action to perform when the event is detected), timestamp, etc.

In 330, a first subset of parameters of the set of parameters provided with the request is identified. For example, parser 116 may identify one or more user parameters 118 provided with the request 108. The user parameters 118 may include a subset of information necessary to create a new event 104, in accordance with event specification 120. In some embodiments, request 108 may include a remove, activate/deactivate, or search request, and user parameters 118 may include parameters corresponding to performing the requested type of command. In some embodiments, the user parameters 118 may include some additional optional parameters of event specification 120.

In 340, a prompt for a large language model (LLM) is generated, the prompt comprising the first subset of parameters as input. For example, prompt generator 122 may generate a parameter prompt 124 to request LLM 126 to generate any missing or not-user-supplied parameters which may be necessary to create event 104. Parameter prompt 124 may include the request 108, user identifier, and any identified user parameters 118.

In 350, a second subset of parameters of the set of parameters for generating the event is received from the LLM. For example, LLM 126 may generate derived parameters 128 from the user parameters 118 and request 108, which may be submitted as input with parameter prompt 124.

In 360, the event is generated based on the first subset of parameters provided with the request and the second subset of parameters provided by the LLM. For example, EGS 102 may combine the user parameters 118 and derived parameters 128 to generate an event 104, register the event 104 with an event manager 210, which is accessible to a monitor 132.

In 370, the event is detected. For example, monitor 132 may detect when the event 104 occurs on a database 130 (e.g., when particular data is updated, added, deleted, or otherwise changed).

In 380, an additional action is performed responsive to the detecting the event. For example, EGS 102 may perform an action 110. The action 110 may include notifying user 106 of the detection of event 104, pausing or stopping processing, or performing any other computing action.

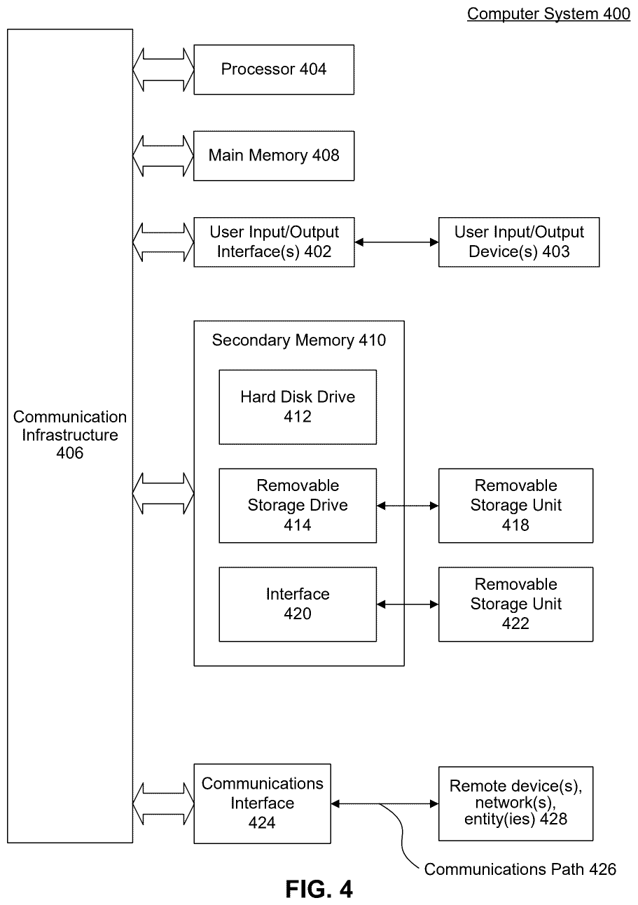

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
receiving, at a chatbot system, a request to create an event;
identifying a set of parameters associated with generating the event;
identifying a first subset of parameters of the set of parameters provided with the request;
generating a prompt for a large language model (LLM), the prompt comprising the first subset of parameters as input;
receiving, from the LLM, a second subset of parameters of the set of parameters for generating the event;
generating the event based on the first subset of parameters provided with the request and the second subset of parameters provided by the LLM;
detecting the event; and
performing an additional action responsive to the detecting the event.

2. The computer-implemented method of claim 1, wherein the event corresponds to detecting when a data value in a data object has been updated.

3. The computer-implemented method of claim 1, wherein the request is received from a user.

4. The computer-implemented method of claim 1, wherein the receiving the request comprises:
determining that the request is not understandable by the chatbot system;
generating a clarification prompt for the LLM, the clarification prompt including the request as input; and
receiving, from the LLM, the first set of parameters in response to the clarification prompt.

5. The computer-implemented method of claim 1, wherein the receiving the request comprises:
determining that the request is missing one or more required parameters; and
generating a prompt for a user to provide the one or more required parameters.

6. The computer-implemented method of claim 1, wherein the performing comprises generating a notification that the event has been detected.

7. The computer-implemented method of claim 1, wherein the request comprises a request to update an existing event.

8. A system comprising:
a memory; and
at least one processor coupled to the memory and configured to perform operations comprising:
receiving, at a chatbot system, a request to create an event;
identifying a set of parameters associated with generating the event;
identifying a first subset of parameters of the set of parameters provided with the request;
generating a prompt for a large language model (LLM), the prompt comprising the first subset of parameters as input;
receiving, from the LLM, a second subset of parameters of the set of parameters for generating the event;
generating the event based on the first subset of parameters provided with the request and the second subset of parameters provided by the LLM;
detecting the event; and
performing an additional action responsive to the detecting the event.

9. The system of claim 8, wherein the event corresponds to detecting when a data value in a data object has been updated.

10. The system of claim 8, wherein the request is received from a user.

11. The system of claim 8, wherein the receiving the request comprises:
determining that the request is not understandable by the chatbot system;
generating a clarification prompt for the LLM, the clarification prompt including the request as input; and
receiving, from the LLM, the first set of parameters in response to the clarification prompt.

12. The system of claim 8, wherein the receiving the request comprises:
determining that the request is missing one or more required parameters; and
generating a prompt for a user to provide the one or more required parameters.

13. The system of claim 8, wherein the performing comprises generating a notification that the event has been detected.

14. The system of claim 8, wherein the request comprises a request to update an existing event.

15. A non-transitory computer-readable medium having instructions stored thereon that,
when executed by at least one computing device, cause the at least one computing device to perform operations comprising:
receiving, at a chatbot system, a request to create an event;
identifying a set of parameters associated with generating the event;
identifying a first subset of parameters of the set of parameters provided with the request;
generating a prompt for a large language model (LLM), the prompt comprising the first subset of parameters as input;
receiving, from the LLM, a second subset of parameters of the set of parameters for generating the event;
generating the event based on the first subset of parameters provided with the request and the second subset of parameters provided by the LLM;
detecting the event; and
performing an additional action responsive to the detecting the event.

16. The non-transitory computer-readable medium of claim 15, wherein the event corresponds to detecting when a data value in a data object has been updated.

17. The non-transitory computer-readable medium of claim 15, wherein the request is received from a user.

18. The non-transitory computer-readable medium of claim 15, wherein the receiving the request comprises:
determining that the request is not understandable by the chatbot system;
generating a clarification prompt for the LLM, the clarification prompt including the request as input; and
receiving, from the LLM, the first set of parameters in response to the clarification prompt.

19. The non-transitory computer-readable medium of claim 15, wherein the receiving the request comprises:
determining that the request is missing one or more required parameters; and
generating a prompt for a user to provide the one or more required parameters.

20. The non-transitory computer-readable medium of claim 15, wherein the performing comprises generating a notification that the event has beenbene detected.
